(19) United States
(12) Patent Application Publication
(10) Pub. No.: US 2006/0128190 A1
(43) Pub. Date: Jun. 15, 2006

(54) Slide mechanism of portable device and cellular phone

(76) Inventor: Hideo Kato, Yokohama (JP)

Correspondence Address: NOTARO AND MICHALOS, 100 DUTCH HILL ROAD, SUITE 110, ORANGEBURG, NY, 10962-2100, US

(21) Appl. No.: 11/292,914

(22) Filed: Dec. 1, 2005

(30) Foreign Application Priority Data
Dec. 13, 2004 (JP) 2004-360449

(51) Int. Cl. H01R 13/62

(52) U.S. Cl. 439/157

(57) ABSTRACT

In order to provide a slide mechanism of portable devices which is possible size reductions, the slide mechanism which can form a closed state by slidably engaging both sides of a first box and both sides of a second box forming a portable device, and covering an upper surface of either the first box or the second box by the other box, and an open state exposing an upper surface of the box, includes: a guide groove provided on both sides of either the first box or the second box, and extending in the longitudinal direction thereof; a slide unit provided near an end portion of both sides of the other box, slidably pressure contacting into the guide groove under given elasticity; and a slide member attached to the slide unit and slidably engaging with the guide groove without rotation.

### BACKGROUND OF THE INVENTION

1. Field of the Invention

The present invention relates to a slide mechanism of portable devices suitable to be used when a first box and a second box which constructs a portable device such as a cellular phone or the like are slid relatively and a cellular phone provided with a slide mechanism of the portable device.

2. Description of the Related Art

In a cellular phone which is a kind of portable devices, a device attached with a slide mechanism is currently on the market, which includes a first box as a transmitter part provided with a key board part, a microphone part, and the like on the upper surface, and a second box as a receiver part provided with a display part, a speaker part and the like on the upper surface, and forms a closed state in which these first and second boxes overlap each other so that the upper surface of the first box is covered by the second box, and an open state in which the second box is slid in the longitudinal direction to the first box to expose the upper surface of the first box. As a cellular phone having a slide mechanism like this, the one described in Japanese Patent Application Laid-open No. 2004-235897 is well known.

The device described in Japanese Patent Application Laid-open No. 2004-235897 has a structure such that a guide groove is provided on both sides of the second box (a receiver part), extending in the longitudinal direction from near the rear to near the tip thereof, and guide members to engage with the guide grooves respectively are provided at two places—one near the center and one near the tip—on both sides of the first box (a transmitter part), so that both sides of the second box and both sides of the first box can be slidably engaged with each other. According to such a structure, in a closed state, the first box and the second box overlap each other so that the upper surface of the first box is covered by the second box. In other words, the guide member at the center of the first box is placed at the center of the guide groove of the second box, and at the same time, the guide member near the tip is placed near the tip of the guide groove of the second box. From this closed state, the second box is slid in the longitudinal direction with respect to the first box, so that the guide member at the center of the first box is positioned near the rear of the guide groove of the second box and at the same time the guide member near the tip is positioned at the center of the guide groove of the second box, thereby making an open state due to exposure of the upper surface of the first box. However, in this open state, since a portion from substantially the center to the tip of the first box and a portion from substantially the center to the rear of the second box overlap each other, each length in the longitudinal direction of the first box and the second box becomes long, which makes it difficult to make the device compact.

### SUMMARY OF THE INVENTION

The present invention is achieved to solve the above-described problem, and the object is to provide a slide mechanism for a portable device which can realize size reductions and a cellular phone having the slide mechanism for the portable device.

A slide mechanism of a portable device relating to the present invention to achieve the above-described object is a slide mechanism forming a closed state by engaging both sides of a first box with both sides of the second box each other, both boxes composing a unit of portable device, to cover an upper surface of either one box of the first box or the second box with the other box of either the first box or the second box, and an open state by exposing the upper surface of above-described one box including: a guide groove provided on both sides of either one box of the first box or the second box, extending in the longitudinal direction thereof; a slide unit provided near both sides of the other box of either the first box or the second box, slidably pressure contacting into the guide groove under given elasticity; and

a slide member attached to the slide unit and slidably engaging with the guide groove without rotation.

According to the present invention, provision of the guide groove, the slide unit to slidably pressure contact into the guide groove under given elasticity, and the slide member to slidably engage with the guide groove without rotation prevent the other box from rotating around the slide member with respect to the one box. Accordingly, since the slide members can take its position near the other end of the guide groove when the second box is slid in the longitudinal direction with respect to the first box from a closed state, the exposed portion on the upper surface of one box becomes larger, i.e., from near the end of the other box to the end of the box. Therefore, in an open state, the portion where the first box and the second box overlap each other becomes smaller, and especially, the length in the longitudinal direction of the first box and the second box can be shortened, which makes possible a size reduction of the device.

In a slide mechanism of a portable device relating to the present invention, the guide groove is preferably formed linearly. Furthermore, in the slide mechanism of a portable device relating to the present invention, the guide groove is preferably formed in a curved shape so that the open angle formed between the first box and the second box in an open state is obtuse. In addition to that, in the slide mechanism of a portable device relating to the present invention, it is preferable to provide a pivot part in the guide groove, which makes the open angle between the first box and the second box obtuse when the first box and the second box slide from the closed state to the open state and pivot while sliding after the sliding in a linear direction. Still further, in the slide mechanism of a portable device relating to the present invention, it is preferable to provide a pivot part in the guide groove, which makes the open angle formed between the first box and the second box obtuse by respectively rotating the first box and the second box in the open state around the slide member. It should be noted that an open angle in the present invention indicates an angle on the upper surface side (an angle shown by a symbol α in FIG. 5B) of the first box among the angles formed between straight lines extending in the longitudinal direction of the first box and second box.

Furthermore, in the slide mechanism of a portable device relating to the present invention, it is preferable to provide a concave engagement part in the guide groove, which engages with the slide unit and holds the first box and the second box in a locked state at a prescribed position. Further in the slide mechanism of a portable device relating to the present invention, the slide unit preferably includes a convex member provided in a manner possible to appear and disappear. Also, in the slide mechanism of a portable device relating to the present invention, it is preferable that the slide unit includes a case body attached to the other box having a bearing housing hole, a ball bearing accommodated in the case body such that the ball bearing can appear and disappear from and into the bearing housing hole, and a compression coil spring to force the ball bearing in a protruding direction.

A cellular phone relating to the present invention provides the slide mechanism of a portable device relating to the present invention. According to the present invention, since the other box never rotates around the slide member with respect to one box similarly to the cases described above, a portion where the first box and the second box overlap each other is small in an open state, which makes possible a size reduction.

As explained above, according to the slide mechanism of the portable device and the cellular phone relating to the present invention, since no rotation of the other box around the slide member with respect to one box, in an open state, a portion where the first box and the second box overlap each other is small, which makes possible a size reduction.

### BRIEF DESCRIPTION OF THE DRAWINGS

FIGS. 1A, 1B and 1C are side views showing an example of a cellular phone provided with a slide mechanism of a first portable device relating to the present invention, and FIG. 1A is a view showing a closed state, FIG. 1B is a view showing an intermediate state, and FIG. 1C is a view showing an open state;

FIG. 2 is a schematic sectional view showing an example of a slide mechanism of a portable device relating to the present invention;

FIGS. 3A, and 3B are perspective views showing an example of a slide member relating to the present invention, FIG. 3A is a view showing a manner of fixing and FIG. 3B is an exploded view;

FIGS. 4A, 4B, 4C and 4D are views showing an example of a convex portion relating to the present invention, where FIG. 4A is a exploded perspective view, FIG. 4B is a side sectional view, FIG. 4C is a side view, and FIG. 4D is a front view;

FIGS. 5A and 5B are side views showing an example of a cellular phone provided with a slide mechanism of a second portable device relating to the present invention, FIG. 5A is a view showing a closed state, and FIG. 5B is a view showing an open state;

FIG. 6 is a plan view showing an open state of an example of a cellular phone provided with the slide mechanism of the second portable device relating to the present invention;

FIG. 7 is a perspective view showing an example of a guide groove and a rotation part relating to the present invention;

FIGS. 8A, 8B, and 8C are side views showing an example of a second cellular phone provided with a slide mechanism of a portable device relating to the present invention, where FIG. 8A is a view showing a closed state, FIG. 8B and FIG. 8C are views showing an open state;

FIG. 9 is a perspective view showing another example of the guide groove and the rotation part relating to the present invention; and

FIGS. 10A and 10B are side views showing an example of a cellular phone provided with a slide mechanism of a fourth portable device relating to the present invention, where FIG. 10A is a view showing a closed state and FIG. 10B is a view showing an open state.

### DETAILED DESCRIPTION OF THE PREFERRED EMBODIMENT(S)

Slide mechanisms of a portable device and cellular phones relating to the present invention will be explained in details with reference to the attached drawings hereinafter.

### Embodiment 1

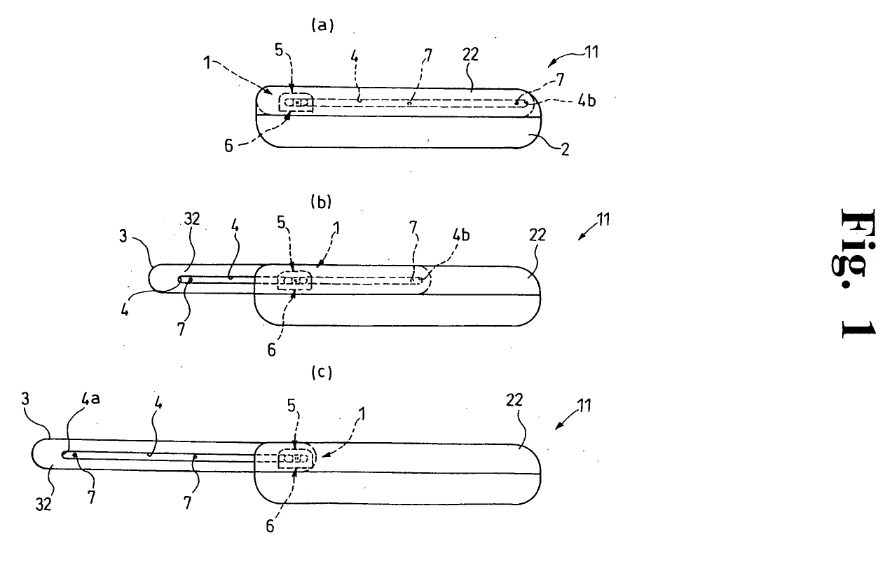

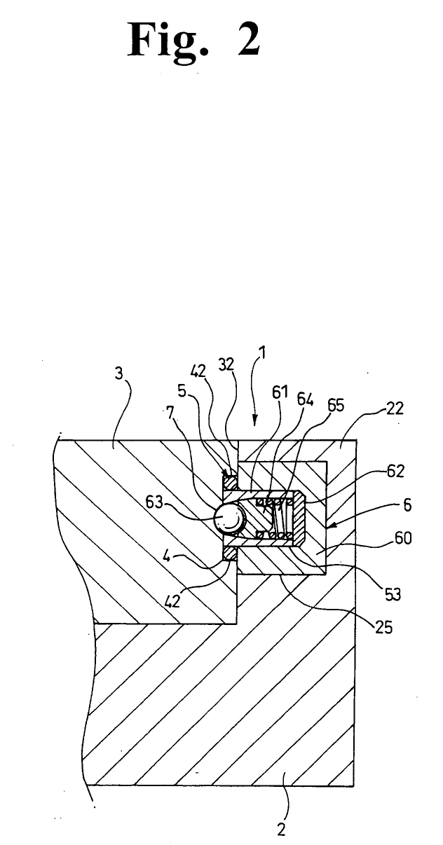

FIG. 1A to FIG. 2 show an example of cellular phones provided with a slide mechanism of a first portable device relating to the present invention. The slide mechanism of the first portable device relating to the present invention forms a closed state (refer to FIG. 1A) in which the upper surface of either a first box 2 or a second box 3, for instance, the first box 2, is covered by the other box, for instance, the second box 3, and an open state (refer to FIG. 1C) in which the upper surface of the first box 2 is exposed, by making both sides 22 of the first box 2 constructing a portable device and both sides 32 of the second box 3 slide each other. There is no specific limitation for the portable device, and, for instance, a portable information terminal device such as a cellular phone, Zaurus (trade name), and the like, an electronic calculator, a pocket computer, a portable game machine, and so on are cited, and especially, a cellular phone is preferable. It should be noted that an ash tray, a case lid, and the like other than the above can be cited as a portable device according to the present invention. In other words, there is no limitation so far as it makes two objects slide each other. Though a cellular phone 11 is given as an illustration of a portable device in this embodiment, it is not limited to this.

A slide mechanism 1 of the first portable device 1 relating to the present invention includes a guide groove 4 provided on both sides 32 of either one box of the first box 2 or the second box 3, for instance, the second box 3; a slide unit 6 provided near the end of both sides 22 of either the other box of the first box 2 or the second box 3, for instance, the first box 2, and slidably pressure contacts into the guide groove 4 in a state under given elasticity; and a slide member 5 fixed on the slide unit 6 and slidably engages with the guide groove 4 without rotation.

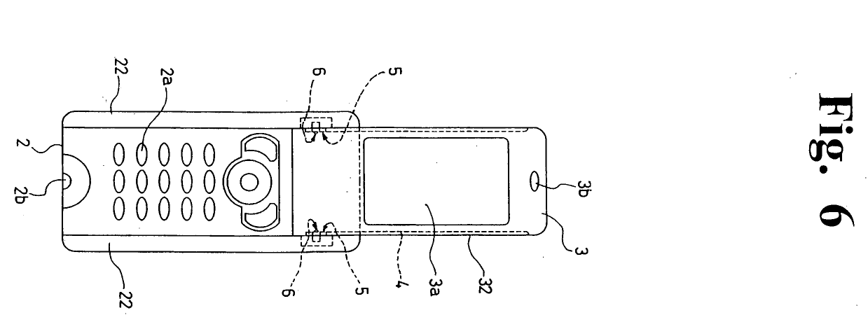

The first box 2 constructs a transmitter part of the cellular phone 11, and is provided with a key board part 2a (refer to FIG. 6), a microphone part 2b (refer to FIG. 6) and the like on the upper surface thereof. The first box 2 is formed in a slender and substantially rectangular shape in which both sides 22 protrude upward from the upper surface respectively in a substantially U shape. The second box 3 constructs a receiver part of the same cellular phone, and is provided with a display part 3a of LCD or the like (refer to FIG. 6), a speaker part 3b (refer to FIG. 6) and the like on the upper surface thereof. The second box 3 is formed in a substantially rectangular shape of somewhat shorter size but with nearly the same width as the width of the first box 2, and a shorter lateral length than the lateral length of the first box 2. The thickness of the second box 3 is formed in nearly the same height as, for instance, the height of both sides 22 of the first box 2, and the second box 3 is fitted between both sides 22 of the first box 2 so that it can overlay on the first box 2. The guide grooves 4 are provided on the second box sides 32.

The guide groove 4 engages with the slide member 5 to make the first box 2 and the second box 3 slide linearly without rotation. The guide groove 4 is formed linearly on both sides 32 of the second box 3 in the longitudinal direction thereof from the tip (the end on the side of the speaker part 3b) to the rear (the end on the opposite side to the tip).

The slide member 5 is attached near the tip (the end on the opposite side to that provided with the microphone part 2b) inside both sides 22 of the first box 2, and engages with the guide groove 4 so that the first box 2 and the second box 3 can slide each other in the longitudinal direction thereof, namely linearly between a closed state and an open state.

In other words, a state that the second box 3 is fitted between both sides 22 of the first box 2, and the upper surface of the first box 2 is covered by the second box 3 is a closed state, and the slide member 5 is placed at the tip of the guide groove 4 at this time. And from this state, when the second box 3 is slid toward the tip from the rear of the first box 2 with respect to the first box 2 to place the slide member 5 on the rear of the guide groove 4, the upper surface of the first box 2 is exposed, which is an open state. It is also possible that the second box is formed in substantially convex by protruding a portion of the bottom surface, and the protruded portion is fitted between both sides 22 of the first box 2 to cover the whole upper surface of the first box 2 with the second box. Though the slide member 5 is provided on the first box 2 and the guide groove 4 is provided on the second box 3 so that the first box 2 and the second box 3 are slidably connected to each other, the first box 2 and the second box 3 can be slidably connected by providing the slide member to the second box 3 and at the same time by providing the guide groove to the second box 3.

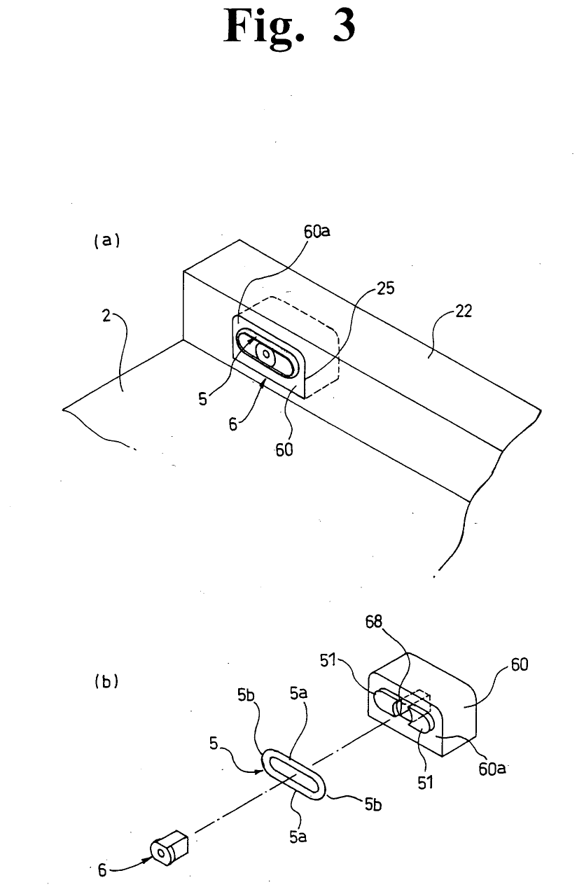

The slide member 5 can be formed integrally with the side portion 22 of the first box 2, but it is preferable to provide them individually. The slide member 5 engages with the guide groove 4 and slidably moves in the guide groove 4 to allow the first box 2 and the second box 3 to slide linearly on each other, and is formed such that the second box 3 does not rotate around the slide member 5 with respect to the first box 2. The slide member 5 is preferably formed, as shown in FIG. 2 and FIGS. 3A and 3B, in a slender oblong ring composed of, for instance, two linear parallel portions 5a, 5a and two semicircles 5b, 5b. The guide case 60 is to accommodate the slide unit 6 which slidably pressure contacts with the guide groove 4 in a state under given elasticity, which is a component of the slide unit 6. Note that the oblong in the present invention is a shape formed by connecting both ends of the parallel portions with the semicircles or arcuate curved portions respectively. The slide member 5 is preferably formed with, for instance, a wear-resistant material.

The slide member 5 is detachably attached to, for instance, a slide member attachment part 51. The slide member attachment part 51 can be integrally provided with both sides 22 of the first box 2, or can be provided to a guide case 60 housed fittedly in an accommodation part 25 provided on both sides 22. The guide case 60 is formed substantially in a rectangular box in which a side surface (sometimes being called a sliding surface 60a) is placed on the same plane (including nearly the same) as an internal surface of both sides 22 when accommodated in the accommodation part 25. The slide member attachment part 51 is provided on a sliding surface 60a so as to protrude from the surface. The slide member attachment part 51 is formed from two members prepared by, for instance, shaving away the center of an oblong member which is made by making both ends a slender rectangle extending in the longitudinal direction of both sides 22 to be semicircular. The slide members 5 are detachably attached in the periphery of these slide member attachment parts 51, 51 such that the slide members 5 are fitted thereinto. A convex engagement fitting part 68 accommodating the slide unit 6 is provided between the slide member attachment part 51, 51. It should be noted that the slide member 5 can be directly attached to the slide unit 6 without through the slide member attachment part 51.

The width of the slide member 5 (length between parallel portions 5a and 5a) is preferably a little narrower than the width of the guide groove 4. Through this formation, the parallel portions 5a, 5a of the slide member 5 come in contact with or draw near both side walls 42, 42 which form the guide groove 4 respectively so that the first box 2 and the second box 3 are slidably engaged linearly with each other and at the same time the second box 3 does not rotate around the slide member 5 with respect to the first box 2.

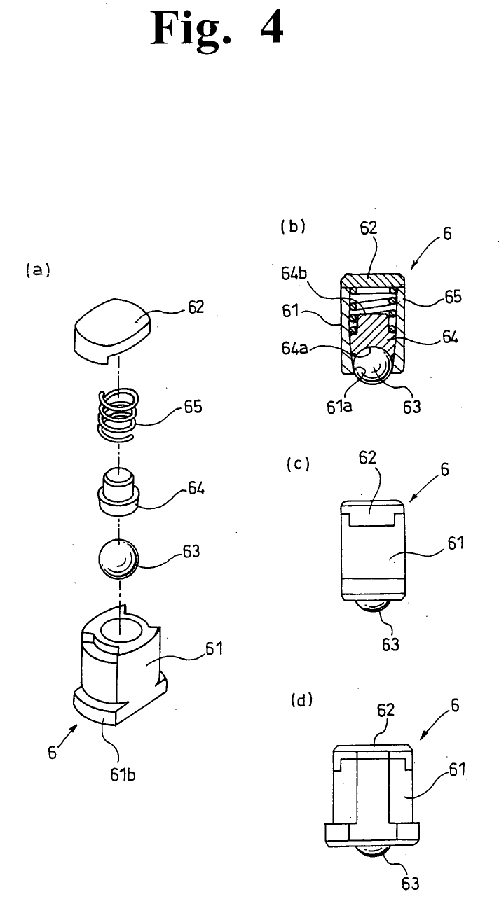

The slide unit 6 is to slidably pressure contact into the guide groove 4 in a state under given elasticity, and includes a case body 61, a lid body 62, a convex member, a seating member, and a biasing member other than the guide case 60, as shown in FIG. 2 and FIGS. 4A, 4B, 4C, and 4D.

The case body 61 is formed substantially in a cylindrical shape fitted into and accommodated in the convex engagement fitting part 68. The inside of the case body 61 is formed in a circle which gradually shortens in diameter from near the center to the end (being called the tip sometimes). In other words, the opening part at the tip of the case body 61 (being called a bearing housing hole 61a sometimes) is formed in a diameter smaller than that of the opening part at the other portion (being called the rear sometimes). The outer shape of the case body 61 is formed in an oblong, and the tip thereof is formed in a further slender oblong to be a flange part 61b.

A ball bearing 63 which is a convex member is accommodated in the case body 61. The ball bearing 63 is formed to have a diameter larger than the diameter of the bearing housing hole 82a, for instance, a little larger size in diameter, so that a portion of the ball bearing can project from the bearing housing hole 82a in a state accommodated in the case body 61.

The opening part of the rear of the case body 61 is covered by the lid body 62. The lid body 62 is for covering the opening part at the rear, and is formed, for instance, in an oblong having substantially the same shape and size as the outside shape of the case body 61. The lid body 62 is fixed to the case body 61 by, for instance, ultrasonic welding in a state of covering the opening part of the rear of the case body 61. Through this structure, the ball bearing 63 is prevented from coming out of the case body 61. The case body 61 and the lid body 62 are formed in such size and shape that the tip of the case body 61 is on the same (or substantially the same) plane as the surface of the slide member attachment part 51 when the case body 61 to which the lid body 62 is fixed is accommodated in the convex engagement fitting part 68.

A seating member 64 supporting the ball bearing 63 is accommodated in the case body 61. The seating member 64 is formed substantially in a column. A dome-shaped supporting part 64a rotatably supporting the ball bearing 63 and having the same diameter as that of the ball bearing 63 is provided in the end of the seating member 64. A spring fit insertion part 64b to which the end of a compression coil spring 65, a biasing member, is fitted, is provided at the other end of the seating member 64. The other end of the compression coil spring 65 comes in contact with an inner surface of the lid body 62 so that a portion of the ball bearing 63 always projects from the bearing housing hole 61a through the seating member 64 owing to an urging force of the compression coil spring 65 when no other force acts on the ball bearing 63.

An engagement means to hold the first box 2 and the second box 3 at a predetermined position in a locked state is constructed with the ball bearing 63 and the concave engagement parts 7 in the slide unit 6. The concave engagement parts 7 are provided in the guide groove 4. The guide groove 4 engages with the ball bearing 63 to hold, for instance, the second box 3 at an arbitrary position in relation to the first box 2 in a locked state. The positions of the concave engagement parts 7 are arbitrary, and are the following three positions, for instance, a position near the tip of the guide groove 4 to hold the first box 2 and the second box 3 in a closed state to be in a locked state, a position at the center (including substantially the center) of the guide groove 4 to hold the first box 2 and the second box 3 in an intermediate state (in an intermediate state between a closed state and an open state) to be in a locked state, and a position near the rear of the guide groove 4 to hold the first box 2 and the second box 3 in an open state to be in a locked state. The inner surface of the concave engagement part 7 is preferably formed in a spherical surface having the same diameter as the diameter of the ball bearing 63, for instance. Though the slide unit 6 is provided on the first box 2, and the concave engagement part 7 on the second box 3, it is also possible to provide the slide unit on the second box 3 and the concave engagement part 7 on the second box 3 at the same time.

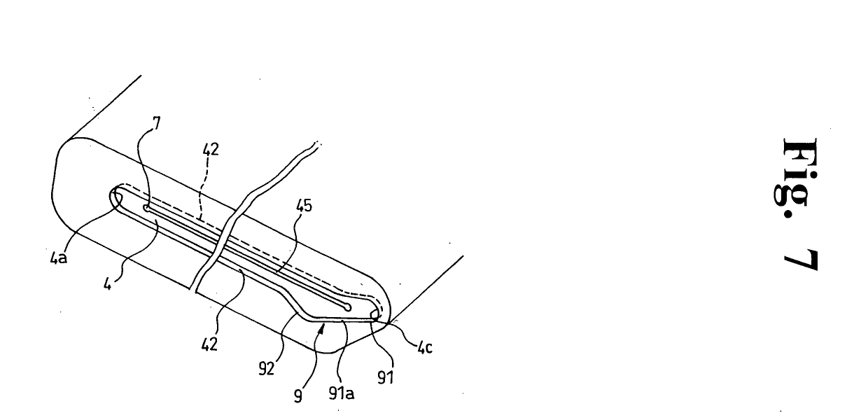

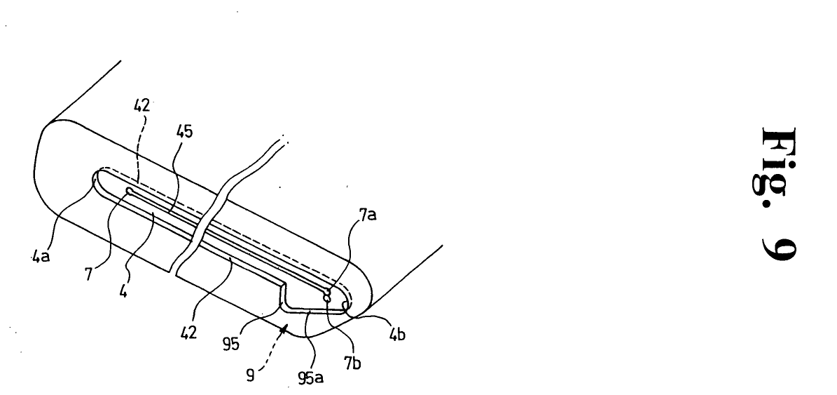

A sliding part 45 (refer to FIG. 7 and FIG. 9) through which the ball bearing 63 slides can be provided in the guide groove 4. The sliding part 45 is preferably formed shallower in depth than the concave engagement part 7, for instance, formed in a circular shape. The sliding part 45 connects to, for instance, the concave engagement part 7, and is formed on a straight line facing the ball bearing 63 when the slid member 5 slidably moves along the guide groove 4.

Next, an operation of a slide mechanism 1 of the first portable device and a cellular phone 11 will be explained.

In a state that the cellular phone 11 is not used, the first box 2 and the second box 3 are usually in a closed state (refer to FIG. 1A), in which the first box 2 and the second box 3 overlap each other. At this time, the ball bearing 63 of the slide unit 6 engages with the concave engagement part 7 near the tip of the guide groove 4 of the second box 3, and the first box 2 and the second box 3 are held in a closed state in a locked state. When starting a call with this cellular phone 11, for instance, the first box 2 is held with the left hand, the second box 3 is held with the right hand at the same time, and the second box 3 is slid with respect to the first box 2 from the rear of the first box 2 toward the tip. Then the ball bearing 63 gets out of the concave engagement part 7 (released from the engagement) and moves into the case body 61 against a force by the compression coil spring 65 and slides on the sliding part 45 in a state of being guided by the sliding part 45, and the second box 3 slides with respect to the first box 2 by engaging the slide member 5 with the guide groove 4.

At this time, since parallel portions 5a, 5a of the slide member 5 respectively come in contact with or come near to both side walls 42, 42 forming the guide groove 4 so that the first box 2 and the second box 3 slide to each other, the second box 3 never rotates around the slide member 5 with respect to the first box 2. As a result, the first box 2 and the second box 3 slide to each other without rotation.

When the slide member 5 reaches the center of the guide groove 4, the ball bearing 63 engages with the concave engagement part 7 at the middle of the guide groove so that the first box 2 and the second box 3 are held in an intermediate state (refer to FIG. 1B). When the second box 3 is further slid with respect to the first box 2 from this intermediate state, the ball bearing 63 gets out of the concave engagement part 7. When the end portion of the slide member 5 comes into contact with the rear 4b of the guide groove 4, the ball bearing 63 engages with the concave engagement part 7 so that the first box 2 and the second box 3 are held in an open state (refer to FIG. 1C).

At this time, since parallel portions 5a, 5a of the slide member 5 respectively come in contact with or come near to both side walls 42, 42 forming the guide groove 4, the second box 3 never rotates around the slide member 5 with respect to the first box 2. Accordingly, the first box 2 and the second box 3 in an open state can be kept in a locked state without rotation of the first box 2 and the second box 3. As a result, communication through a phone can be stably performed.

Furthermore, since the slide member 5 which keeps the open state is placed near the other end of the guide groove 4, an exposed portion on the upper surface of the first box 2 is the major part of the upper surface from near the tip to the rear. Accordingly, in an open state, the overlapped portion of the first box 2 with the second box 3 becomes small, which makes it possible to shorten the length of the first box 2 and the second box 3 in the longitudinal direction so that a size reduction can be realized.

In order to return the second box 3 to the original position, for instance, the first box 2 is held with the left hand and at the same time the second box 3 is held with the right hand, and a force is applied on the second box 3 with respect to the first box 2 from the tip of the first box 2 toward the rear end. Then, the ball bearing 63 gets out of the concave engagement part 7 (released from the engagement), and the second box 3 slides with respect to the first box 2 while the slide member 5 is guided by the guide groove 4. The other end of the slide member 5 comes in contact with the tip 4a of the guide groove 4 and the ball bearing 63 engages with the concave engagement part 7, so that the first box 2 and the second box 3 are held in a closed state, while being overlapping each other, which returns the second box 3 to its original state.

Accordingly, since the slide mechanism 1 of the first portable device 1 and the cellular phone 11 relating to the present invention form a slide member 5 such that the second box 3 slides on the guide groove 4 without rotation around the slide member 5 with respect to the first box 2, an area where the first box 2 and the second box 3 overlap each other becomes small in an open state, which makes possible a size reduction thereof.

When the slide movement is suspended in the middle of sliding the second box 3 with respect to the first box 2, the second box 3 can be stopped at that position. In other words, when the second box 3 is slid with respect to the first box 2, the ball bearing 63 of the slide unit 6 slides along the sliding part 45 in the guide groove 4, and at the same time, is pressed to the sliding part 45 by a force added by the compression coil spring 65. Therefore, when the second box 3 is stopped, it can stop at that position by a friction force due to contact between the ball bearing 63 and the sliding part 45 of the guide groove 4. Then, the second box 3 can be stopped at a desired position with respect to the first box 2.

### Embodiment 2

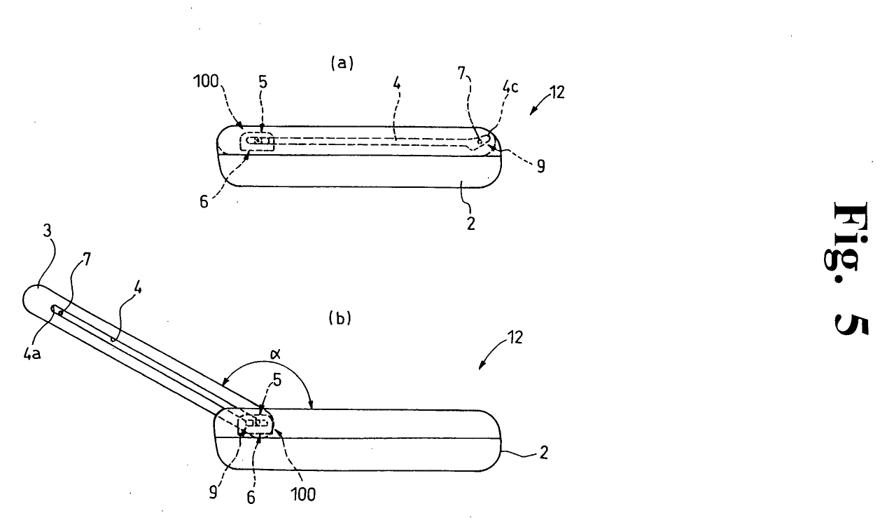

FIGS. 5A, 5B, FIG. 6, and FIG. 7 are views showing a cellular phone provided with a slide mechanism of a second portable device relating to the present invention. A point of difference between the second slide mechanism and the first slide mechanism is that a pivoting part 9 to form the open angle α between the first box 2 and the second box 3 obtuse is provided in the guide groove 4, as shown in FIG. 5A to FIG. 7. Note that the same members as those of the first slide mechanism 1 are attached with the same names, and the explanation thereof will be sometimes omitted.

The pivoting part 9 is provided at the rear of the guide groove 4. The pivoting part 9 makes the open angle α between the first box 2 and the second box 3 obtuse. The open angle α at this time is not limited especially and, for instance, 150°. The angle “150°” is considered to include “roughly 150°” in the present invention. The pivoting part 9 is not limited to a specific member so far as it can make the open angle obtuse, and for instance, when the first box 2 and the second box 3 are slid from a closed state to an open state, it is also possible to make the open angle α obtuse by pivoting still in sliding after the first box 2 and the second box 3 slide in a straight-line direction.

In the pivoting part 9, for instance, as shown in FIGS. 5A, 5B and FIG. 6, an upper portion of the rear 4c of the guide groove 4 bends upward to form an inclined portion 91, and a concave pivot part 92 is formed so that the end of the slid member 5 enters into the inclined portion 91, and the rear end moves downward to make the second box 3 pivotable with respect to the first box 2, and pivoting of the second box 3 is stopped by fitting to the bottom of the concave pivot part 92 and the inclined portion 91. That is, an end of the slide member 5 is held in the tip of the inclined portion 91, and pivot movement of the second box 3 is stopped in a state that a lower parallel portion 52a of the slide member 5 comes in contact with the bottom surface 91a of the inclined portion 91. Accordingly, it is possible to set an open angle at an arbitrary angle, for instance, 150° in particular by adjusting shapes or angles of the tip of the inclined portion 91, the bottom surface 91a, or the like.

The concave engagement parts 7 are formed at two places, for instance, (1) a place near the tip of the guide groove 4 where the first box 2 and the second box 3 in a closed state are held in a locked state, and (2) a place to hold an open state obtained by suspending a pivot movement of the second box 3 in a state that the parallel portion 52a in a lower portion of the slide member 5 comes in contact with the bottome surface 91a of the inclined portion 91 when the second box 3 slidably pivots

By structuring like this, the first box 2 and the second box 3 are usually in a closed state where both boxes are overlapped each other (refer to FIG. 5A) when a cellular phone 12 is not in use. At this time, the ball bearing 63 of the slide unit 6 engages with the concave engagement part 7 near the tip of the guide groove 4 of the second box 3 and the first box 2 and the second box 3 are held in a locked state during a closed state. In order to make a call with the cellular phone 12, for instance, the first box 2 is held with the left hand, the second box 3 is held with the right hand and the second box 3 is slid from the rear of the first box 2 toward the tip with respect to the first box 2. Then, the ball bearing 63 gets out of the concave engagement part 7 (released from the engagement), and moves into the case body 61 against a force added by the compression coil spring 65, and at the same time, slides on the sliding part 45 while guided by the sliding part 45, and the second box 3 slides with respect to the first box 2 due to engagement of the slide member 5 with the guide groove 4.

At this time, since the parallel portion 5a, 5a of the slide member 5 respectively come in contact with or come close to both side walls 42, 42 forming the guide groove 4 so that the first box 2 and the second box 3 slide each other, the second box 3 never rotates around the slide member 5 with respect to the first box 2. As a result, the first box 2 and the second box 3 can slide each other without rotation.

When the slide member 5 slides in the pivoting part 9 of the guide groove 4, the end of the slide member 5 enters into the inclined portion 91, comes into contact with the bottom surface 91a, moves upwards along the bottom surface 91a, and the other end portion of the slide member 5 enters the concave pivot part 92. Thereby, the second box 3 rotates with respect to the first box 2. When the end of the slide member 5 moves into the tip of the inclined portion 91, the lower parallel portion 52a of the slide member 5 comes into contact with the bottom surface 91a of the inclined portion 91 to stop rotation, and the ball bearing 63 engages with the concave engagement part 7 on the rear of the second box 3 to hold in a locked state in an open state at an open angle of, for instant, 150°. In other words, the first box 2 and the second box 3 are, as shown in FIG. 5B and FIG. 6, in an open state possible to call. Through this structure, the microphone part 2b of the first box 2 can be brought close to the mouth, and the speaker part 3b of the second box 3 can be brought close to the ear respectively. Furthermore, in an open state of the open angle at 150°, it becomes easy to operate the key board part 2a of the first box 2 while watching images displayed on the display part 3a of the second box 3, and the operability is improved.

Furthermore, since the slide member 5 to hold the open state is positioned near the other end portion of the guide groove, a portion where the upper surface of the first box 2 is exposed is the major part from near the tip to the rear. As a result, in the open state, a portion where the first box 2 and the second box 3 overlap each other becomes small, especially the length in the longitudinal direction of the first box 2 and the second box 3 makes short, so that size reductions of the portable device can be realized.

In order to return the second box 3 to the original position, for instance, the first box 2 is held with the left hand and at the same time the second box 3 is held with the right hand, and a force is applied on the second box 3 with respect to the first box 2 from the tip of the first box 2 toward the rear. Then, the ball bearing 63 gets out of the concave engagement part 7 (released from the engagement), the other end portion of the slide member 5 enters the guide groove 4 from the concave pivot part 92, the end of the slide member 5 moves downward along the bottom surface 91a and enters into the guide groove 4 to make the second box 3 slide with respect to the first box 2 due to engagement of the slide member 5 with the guide groove 4. Then, the other end portion of the slide member 5 comes into contact with the tip 4a of the guide groove 4, and the ball bearing 63 engages with the concave engagement part 7 on the tip end side of the second box 3 so that the closed state where the first box 2 and the second box 3 overlap each other is held and the second box 3 returns to its original state.

Accordingly, a slide mechanism 100 of the second portable device and the cellular phone 12 relating to the present invention can realize reduced size, enhanced operability, and ease of use.

When the slide movement is suspended in the middle of sliding the second box 3 with respect to the first box 2, the second box 3 can be stopped at that position. In other words, when the second box 3 is slid with respect to the first box 2, the ball bearing 63 of the slide unit 6 slides along the sliding part 45 in the guide groove 4, and at the same time, is pressed to the sliding part 45 by a force added by the compression coil spring 65. Therefore, when the second box 3 is stopped, it can stop at that position by a friction force due to contact between the ball bearing 63 and the sliding part 45 of the guide groove 4. Then, the second box 3 can be stopped at a desired position with respect to the first box 2.

### Embodiment 3

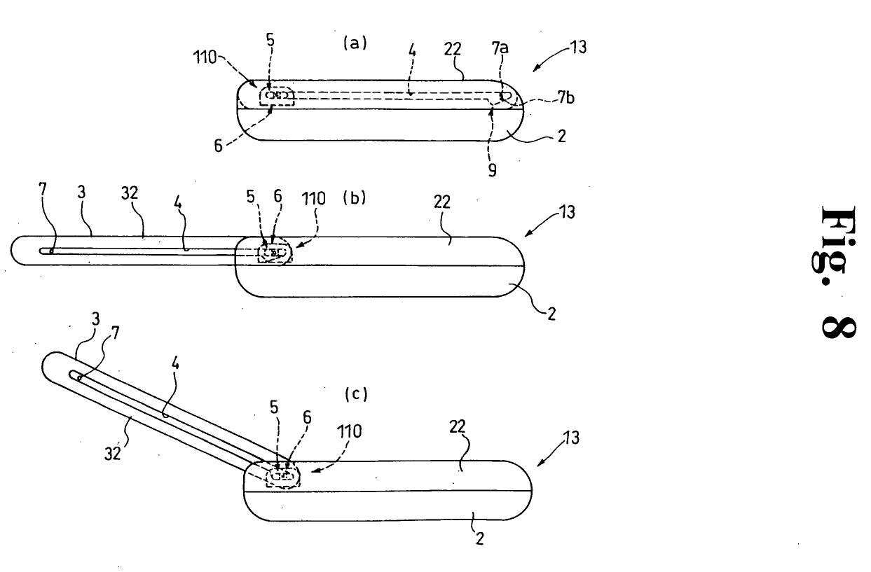

FIGS. 8A, 8B, 8C and FIG. 9 are views showing a cellular phone provided with a slide mechanism of a third portable device relating to the present invention. A point different from the first slide mechanism is that a pivoting part 9 to make the open angle α between the first box 2 and the second box 3 obtuse is provided in the guide groove 4, as shown in FIG. 8A to FIG. 9 (refer to FIG. 5B). Note that the same members as those of the first slide mechanism 1 are attached with the same names, and the explanation thereof will be sometimes omitted.

The pivoting part 9 includes a concave pivot part 95 formed at a lower portion of the rear 4c of the guide groove 4. The guide groove 4 is formed to be a closed state where the upper surface of the first box 2 is covered by the second box 3, and an open state where the upper surface of the first box 2 is exposed when, for instance, the second box 3 is slid from the rear of the first box 2 toward the tip end thereof in the longitudinal direction, namely, linearly with respect to the first box 2 when in a closed state, and an end portion of the slide member 5 comes in close contact with the rear 4b of the guide groove 4. The rear 4b of the guide groove 4 is formed in a semicircle so that a semicircle 52b at the end of the slide member 5 can be fitted therein.

The concave pivot part 95 functions to pivot the first box 2 and the second box each other in an open state in which an end portion of the slide member 5 comes in contact with the rear 4c of the guide groove 4 around an axis of the semicircle 52b at an end of the slide member 5 as a pivoting axis. The bottom surface 95a of the concave pivot part 95 is an inclined plane, and the pivot movement is stopped when the lower parallel portion 52a of the slide member 5 comes in contact with this bottom surface. Accordingly, by adjusting the angle of the bottom surface 95a of the concave pivot part 95, it is possible to set an open angle at an arbitrary angle, for instance, 150° in particular.

The concave engagement parts 7 are formed at three places, for instance, at a first position near the tip of the guide groove 4 where the first box 2 and the second box 3 in a closed state are held in a locked state, at a second position where an open state (being called a first open state sometimes) obtained by sliding the first box 2 and the second box 3 linearly on each other and abutting an end portion of the slide member 5 on the rear 4c of the guide groove 4 is held in a locked state (a concave engagement part 7 provided at this position is taken as a first concave engagement part 7a), and at a third position where an open state (a second open state) obtained by further rotating the first box 2 and the second box 3 in the first open state and stopping the rotation when the parallel portion 52a of the slide member 5 comes in contact with the bottom surface 95a of the concave pivot part 95 is held in a locked state (a concave engagement part 7 provided at this position is taken as a second concave engagement part 7b).

Even structuring like this, a reduction in size and operability are improved. In other words, when the cellular phone 13 is not in use, it is usually in a closed state in which the first box 2 and the second box 3 overlap each other (refer to FIG. 8A). At this time, the ball bearing 63 of the slide unit 6 engages with the concave engagement part 7 near the tip of the guide groove 4 of the second box 3, and the first box 2 and the second box 3 are in a closed state and are held in a locked state. In order to talk over this cellular phone 13, for instance, the first box 2 is held by the left hand and at the same time the second box 3 is held by the right hand, and the second box 3 is slid from the rear of the first box 2 toward the tip end with respect to the first box 2. Then, the ball bearing 63 gets out of the concave engagement part 7 (released from the engagement) and moves into the case body 61 against a force added by the compression coil spring 65, slides on the sliding part 45 while being guided by the sliding part 45 so that the second box 3 slides with respect to the first box 2 due to engagement of the slide member 5 with the guide groove 4.

At this time, since the parallel portion 5a, 5a of the slide member 5 respectively come in contact with or come close to both side walls 42, 42 forming the guide groove 4 so that the first box 2 and the second box 3 slide each other, the second box 3 never rotates around the slide member 5 with respect to the first box 2. As a result, the first box 2 and the second box 3 can slide each other without rotation.

When an end portion of the slide member 5 comes in contact with the rear 4b of the guide groove 4, the ball bearing 63 engages with the first concave engagement part 7a, and the first box 2 and the second box 3 are held in the first open state (refer to FIG. 8B). When the first box 2 and the second box 3 in the first open state are slid further on each other, the parallel portion 52a of the slide member 5 comes in contact with the bottom surface 95a of the concave pivoting part 95, and at the same time, the ball bearing 63 gets out of the first concave engagement part 7a to engage with the second concave engagement part 7b so that the first box 2 and the second box 3 are locked at an open angle of, for instance, 150°. In other words, the first box 2 and the second box 3 are in an opened state possible to talk over the phone (refer to FIG. 8C and FIG. 6). Through this structure, the microphone part 2b of the first box 2 can be brought close to the mouth, and the speaker part 3b of the second box 3 can be brought close to the ear respectively. Furthermore, in an open state of the open angle at 150°, it becomes easy to operate the key board part 2a of the first box 2 while watching images displayed on the display part 3a of the second box 3, and the operability is improved.

In order to return the second box 3 to the original position, the first box 2 and the second box 3 in the second open state are rotated in an opposite direction with each other, and the upper parallel portion 52a of the slide member 5 comes into contact with the upper wall of the guide groove 4 and, at the same time, the ball bearing 63 gets out of the second concave engagement part 7b and engages with the first concave engagement part 7a. A force is applied to the second box 3 from the tip of the first box 2 toward the rear with respect to the first box 2. Then the ball bearing 63 gets out of the first concave engagement part 7a and the second box 3 slides with respect to the first box 2 due to engagement of the slide member 5 with the guide groove 4. Then, the other end of the slide member 5 comes in contact with the tip of the guide groove 4 and the ball bearing 63 engages with the concave engagement part 7 on the tip of the second box 3 to hold a closed state in which the first box 2 and the second box 3 overlap each other so that the second box 3 is returned to the original state.

Accordingly, a slide mechanism 110 of the third portable device and the cellular phone 13 relating to the present invention can realize reduced size, enhanced operability and ease of use.

When the slide movement is suspended in the middle of sliding the second box 3 with respect to the first box 2, the second box 3 can be stopped at that position. In other words, when the second box 3 is slid with respect to the first box 2, the ball bearing 63 of the slide unit 6 slides along the sliding part 45 in the guide groove 4, and at the same time, is pressed against the sliding part 45 by the force added with the compression coil spring 65. Therefore, when the second box 3 is stopped, it can stop at that position by a friction force due to contact between the ball bearing 63 and the sliding part 45 of the guide groove 4. Then, the second box 3 can be stopped at a desired position with respect to the first box 2.

### Embodiment 4

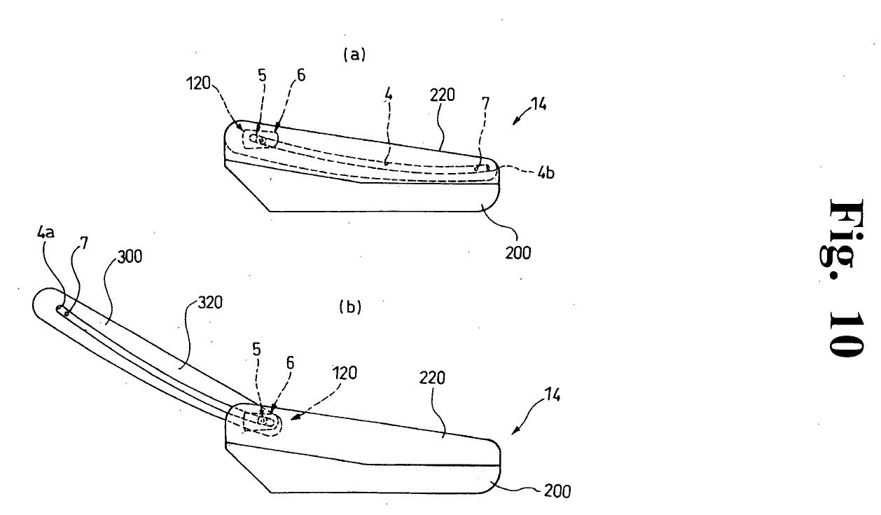

FIGS. 10A and 10B are views showing a cellular phone provided with a slide mechanism of a fourth portable device relating to the present invention. A different point of the fourth slide mechanism from the first slide mechanism is, as shown in FIGS. 10A and 10B, formation of a guide groove 4 and a slide member 5 in a curved shape. Note that the same members as those of the first slide mechanism are attached with the same names, and the explanation thereof will be sometimes omitted.

The guide groove 4 extends to both sides 320 of a second box 300 in the longitudinal direction thereof, and forms in a curved shape from a tip end (an end on a speaker side) toward a rear end (the end opposite to the tip). The guide groove 4 is preferably formed such that the open angle α between a first box 200 and the second box 300 is an obtuse angle, for instance, 150°.

Two parallel portions of a slide member 5 are formed in a curved shape according to the curvature of the guide groove 4. Through this formation, the slide member 5 engages with the guide groove 4 so that the first box 200 and the second box 300 slide each other in the curved direction.

Concave engagement parts 7 are formed at two places, for instance, at a first position near the tip of the guide groove 4 where the first box 200 and the second box 300 in a closed state are held in a locked state, and at a second position near the rear of the guide groove 4 where the first box 200 and the second box 300 in an open state are held in a locked state.

By structuring like this, the first box 200 and the second box 300 are usually in a closed state where both boxes are overlapped each other (refer to FIG. 10A) when a cellular phone 14 is not in use. At this time, the ball bearing 63 of the slide unit 6 engages with the concave engagement part 7 near the tip of the guide groove 4 of the second box 300 and the first box 200 and the second box 300 are held in a locked state during a closed state. In order to make a call with the cellular phone 14, for instance, the first box 200 is held with the left hand, the second box 300 is held with the right hand and the second box 300 is slid from the rear of the first box 200 toward the tip with respect to the first box 200. Then, the ball bearing 63 gets out of the concave engagement part 7 (released from the engagement), and moves into the case body 61 against a force by the compression coil spring 65, and at the same time, slides on the sliding part 45 while guided by the sliding part 45, and the second box 300 slides with respect to the first box 200 due to engagement of the slide member 5 with the guide groove 4.

At this time, since the parallel portion of the slide member 5 respectively come in contact with or come close to both side walls forming the guide groove 4 so that the first box 200 and the second box 300 slide each other, the second box 300 never rotates around the slide member 5 with respect to the first box 200. As a result, the first box 200 and the second box 300 can slide each other without rotation.

When an end of the slide member 5 comes in contact with the rear 4b of the guide groove 4, the ball bearing 63 engages with the concave engagement part 7, the first box 200 and the second box 300 form an open state, for instance, at 150° and are held in a locked state without rotation. Through this structure, the microphone part of the first box 200 can be brought close to the mouth, and the speaker part of the second box 300 can be brought close to the ear respectively. Furthermore, in an open state of the open angle at 150°, it becomes easy to operate the key board part of the first box 200 while watching images displayed on the display part of the second box 300, and the operability is improved.

Furthermore, since the slide member 5 which keeps the open state is placed near the other end of the guide groove 4, an exposed portion on the upper surface of the first box 200 is the major part of the upper surface from near the tip to the rear. Accordingly, in an open state, an overlapped portion of the first box 200 with the second box 300 becomes small, which makes it possible to shorten the length in the longitudinal direction of the first box 200 and the second box 300 so that a size reduction can be realized.

In order to return the second box 300 to the original position, for instance, the first box 200 is held with the left hand and at the same time the second box 300 is held with the right hand, and a force is applied on the second box 300 with respect to the first box 200 from the tip of the first box 200 toward the rear. Then, the ball bearing 63 gets out of the concave engagement part 7 (released from the engagement), the second box 300 slides in a curve with respect to the first box 200 while the slide member 5 being guided by the guide groove 4. Then, the other end of the slide member 5 comes in contact with the tip 4a of the guide groove 4 and the ball bearing 63 engages with the concave engagement part 7 to hold in a closed state in which the first box 200 and the second box 300 overlap each other so that the second box 300 is returned to the original state.

Accordingly, a slide mechanism 120 of the fourth portable device and the cellular phone 14 relating to the present invention can realize reduced size, enhanced operability, and ease of use.

When the slide movement is suspended in the middle of sliding the second box 300 with respect to the first box 200, the second box 300 can be stopped at that position. In other words, when the second box 300 is slid with respect to the first box 200, the ball bearing 63 of the slide unit 6 slides along the sliding part 45 in the guide groove 4, and at the same time, is pressed to the sliding part 45 by a force added by the compression coil spring 65. Therefore, when the second box 300 is stopped, it can stop at that position by a friction force due to contact between the ball bearing 63 and the sliding part 45 of the guide groove 4. Then, the second box 300 can be stopped at a desired position with respect to the first box 200.

As explained above, since the slide mechanism relating of the present invention is and makes possible size reductions, improving operability and ease of use, it is suitable for use as a slide mechanism of, especially, a cellular phone among portable terminals.

What is claimed is:

1. A slide mechanism forming: a closed state by engaging both sides of a first box with both sides of a second box each other, both boxes composing a unit of a portable device, to cover an upper surface of either one box of said first box or said second box with the other box of either said first box or said second box, and an open state by exposing the upper surface of the one box, comprising:
a guide groove provided on both sides of either one box of said first box or said second box, extending in the longitudinal direction thereof;
a slide unit provided near an end portion of both sides of the other box of either said first box or said second box, slidably pressure contacting into the guide groove under given elasticity; and
a slide member attached to the slide unit and slidably engaging with said guide groove without rotation.

2. The slide mechanism of a portable device according to claim 1, wherein said guide groove is formed linearly.

3. The slide mechanism of a portable device according to claim 1, wherein said guide groove is formed in a curved shape so that the open angle formed between said first box and said second box in an open state is obtuse.

4. The slide mechanism of a portable device according to claim 1, wherein a pivot part is provided in said guide groove, which makes the open angle between said first box and said second box obtuse, when said first box and said second box slide from the closed state to the open state and pivot while sliding after the sliding in a linear direction.

5. The slide mechanism of a portable device according to claim 1, wherein a pivot part is provided in said guide groove, which makes the open angle formed between the first box and the second box obtuse by respectively rotating the first box and the second box in the open state around the slide member.

6. The slide mechanism of a portable device according to claim 1, wherein a concave engagement part is provided in said guide groove, which engages with said slide unit and holds said first box and said second box in a locked state at a prescribed position.

7. The slide mechanism of a portable device according to claim 6, wherein said slide unit comprises a convex member provided in a manner possible to appear and disappear.

8. The slide mechanism of a portable device according to claim 6, wherein said slide unit comprises: a case body attached to the other box, having a bearing housing hole; a ball bearing accommodated in the case body such that the ball bearing can appear and disappear from and into said bearing housing hole; and a compression coil spring to force the ball bearing in a protruding direction.

9. A cellular phone, comprising: the slide mechanism of the portable device according to claim 1.
